(19) United States
(12) Patent Application Publication
(10) Pub. No.: US 2021/0315775 A1
(43) Pub. Date: Oct. 14, 2021

(54) SYRINGE ASSEMBLY AND ADAPTER MEMBER

(71) Applicant: Becton, Dickinson and Company, Franklin Lakes, NJ (US)

(72) Inventors: Amit Uday LIMAYE, Wayne, NJ (US); Tianqi HANG, Orange, NJ (US)

(73) Assignee: Becton, Dickinsn and Company, Franklin Lakes, NJ (US)

(21) Appl. No.: 17/273,769

(22) PCT Filed: Jan. 31, 2019
(86) PCT No.: PCT/US2019/015963

§ 371 Date: Mar. 5, 2021

Related U.S. Application Data
(60) Provisional application No. 62/728,430, filed on Sep. 7, 2018.

(51) Int. Cl. A61J 1/20

(52) U.S. Cl. CPC A61J 1/2065; A61J 1/2096; A61J 1/201

(57) ABSTRACT

A syringe assembly (10) includes a syringe barrel (12) having a proximal end and a distal end (16), a needle hub (20) coupled to the distal end of the syringe barrel. A guide member (30) extends from the needle hub (20) for sliding in an axial opening (76, 118, 132) of an adapter (32, 100, 130) connected to the container (36) or vial containing a medication substance, drug, or pharmaceutical. The guide member (30) has a shape and length for mating with the axial opening (76, 118, 132) in the adapter to guide the needle of the syringe in straight line through a septum (42) in the container where the syringe can be filed and aspirated. In one embodiment, the guide member (30) has a plurality of radially extending ribs (52) mating with complementing axial channels or grooves in the axial opening (76, 118, 132) of the adapter (32).

This application claims priority to U.S. Provisional Application Ser. No. 62/728,430, filed on Sep. 7, 2018, which is hereby incorporated by reference in its entirety.

### FIELD OF THE INVENTION

The present invention is directed to a syringe assembly that cooperates with an adapter member. The adapter member is configured for connecting to a vial or container for filling and aspirating the syringe. The invention is also directed to syringe assembly having a guide member for guiding a needle through a septum in a vial or container.

### DESCRIPTION OF THE RELATED ART

Needle lengths in the range of 4 mm to 5 mm are difficult to insert into a container or vial and aspirate due to the short length and the shape and dimension of the septum on the open end of the vial. The short length requires the needle to pierce a septum in the vial in a straight line to ensure penetration and reduce the risk of the needle bending. The septum of a vial has thickness that varies across the width. The thickness of the septum is typically greater at the outer edges to engage the inner surface of the neck of the vial or container. A central portion of the septum has a thinner area that be pierced by the needle more easily to fill the syringe.

The insertion of a needle into the skin of a patient is determined primarily on the features of the needle and not the features or structure of the needle support as disclosed in Needle Insertion Modeling; Identifiability and Limitations, L. Barbe, Biomedical Signal Processing and Control 2 (207) 191-198. Needle insertion into the skin of patient is generally classified into three phases that influence the injection depth. The first phase corresponds to the initial contact of the needle with the skin where the tissue deforms without puncturing the surface of the skin. A second phase refers to the puncture of the skin and the relaxation of the skin when the insertion force of the needle is stopped. The third phase is where the needle is extracted and pulls or stretches the skin outward as the needle is extracted.

Needle lengths, such as needles having a length of about 4 mm to 5 mm are adapted to inject a medication to a specified target depth in a subcutaneous region. The present invention provides a structure so that a needle can be consistently inserted to a desired target depth. Prior pen needles have the cannula supported on an axial post extending from the hub. The post forms a narrow portion and a relatively wider base that does not contact the skin during the injection, in other pen needles known in the art, a distal face of the hub placed against the injection site may be relatively large, and may be provided with a slight taper at the edge. The edge of the hub can engage the skin when the cannula is inserted at an angle relative to the surface of the skin of the patient.

Various injection devices have been produced where the supporting structure does not contact the skin during injection or extraction of the needle. Other devices have been proposed where the end face of the device is positioned to contact the surface of the skin to limit the depth of penetration into the patient.

Pen-injector delivery devices facilitate self-administration of parenteral medications. Pen needles are a component of needle-based injection systems and consist of a doubled ended cannula assembled into a plastic hub using adhesive. The hub has internal threads, which allow it to be attached to the pen-injector device. Pen needle attachment allows the proximal end of cannula to penetrate through the rubber septum of the Medicament cartridge to create the fluid flow path. For many diabetics maintaining blood glucose control is achieved by performing multiple daily injections of insulin into the subcutaneous (SC) tissue using pen injector delivery devices developed to be a convenient, discreet alternative to the vial and syringe. Numerous pen injectors are commercially available in either disposable or multi-use configurations, each offering various patient-centric features. The distal pen needle cannula interfaces with the delivery site providing a conduit for delivery. Pen needle designs are intended to enable consistent delivery to the target tissue space, minimize leakage of injectate, and reduce pain/discomfort and site effects such as bleeding and bruising associated with the injection. The primary design features, needle length/gauge and hub face geometry, in conjunction with mechanics of the delivery system and injection technique, dictate injection success.

Injections may be performed in the intradermal region, the subcutaneous region and the intramuscular (IM) region of the skin. For many types of injectable medications, including insulin, the SC region is preferred for administering an injection. See, for example, Lo Presti, et al., Skin and subcutaneous thickness at injecting sites in children with diabetes: ultrasound findings and recommendations for giving injection, Pediatric Diabetes (2012).

While the prior devices are generally suitable for the intended use, there is a continuing need for improved devices for filling and aspirating a syringe for delivering a drug or medicament to a patient.

### SUMMARY OF THE INVENTION

The present invention is directed to syringe assembly to assist in piercing the septum in a vial or other container that contains a medication to reduce the risk of bending the syringe needle. The syringe assembly is configured for cooperating with an adapter connected to a container for filling and aspirating the syringe, in one embodiment, the syringe assembly includes a guide member to orient the syringe and needle in a specific alignment with respect to the vial and septum while filling and aspirating the syringe.

The syringe assembly in one embodiment includes a syringe barrel and a needle hub coupled to the distal end of the syringe barrel. A syringe needle extends axially from the needle hub. An adapter is provided for coupling to a vial having septum for cooperating with the syringe and needle for filling the syringe with a medication contained in the vial.

The syringe assembly is primarily used with short needles having a length of about 4 mm to about 6 mm. Needles having a length of about 4 mm are desirable for certain uses, such as in the delivery of insulin where the 4 mm needle delivers the insulin to a desired depth in the patient. Filling 4 mm needle syringe requires insertion of the needle carefully through the septum of a vial containing the insulin or other medication. The syringe assembly provides a mechanism where the needle can be inserted through a septum of a container in a manner that the syringe can be filled for needles of varying lengths. The syringe assembly provides a reduced occurrence of bending or damaging of the needle or the piercing of the septum in a location where the distal tip of the needle embeds in the septum and is unable to contact the contents of the vial or container.

The syringe assembly includes a syringe barrel with a needle extending from a needle hub where the syringe barrel cooperates with an adapter member that is coupled to a vial. In one embodiment, the adapter member has a distal end formed with a coupling member, such as one or more flexible legs. The legs flex outward to receive the neck of the vial or container so that the vial or container is coupled to the adapter. The flexible legs have at least one and typically a plurality of ribs or detents to grip the neck of the container. The needle of the syringe, passes through the adapter into the container for filling the syringe.

The syringe assembly in one embodiment has a guide member with an outer surface having a shape that complements the opening in the adapter member. The guide member and adapter maintain a constant alignment of the needle relative to the septum during insertion to reduce bending of the needle. The guide member generally has a non-circular outer surface and configuration. In other embodiments, the guide member and opening om the adapter can have complementing circular cross sectional profiles. The adapter member has an axial opening with an inner surface corresponding substantially to the shape of the guide member and is typically non-circular. The complementing shape of the guide member and the adapter provide a desired alignment of the needle with the septum of the container to assist in piercing the septum and filling the syringe.

The syringe barrel has a distal end with a needle hub supporting a needle. The needle can have a length suitable for the intended use. In one embodiment, the needle has a length of about 4 mm. An adapter member is configured for coupling to the open end of a vial or container and for receiving the needle and needle hub. The adapter member in one embodiment has a guide surface for guiding the needle into a selected location of the septum of the vial to ensure the needle penetrates the cavity of the vial where the syringe can be filled. In one embodiment, the adapter has an axial opening that centers the needle in the septum as the needle penetrates the septum.

The adapter member has a coupling member, such as a collar with at least one and typically a plurality of axially extending legs for coupling with a vial or container while filling and aspirating the syringe. The legs include an inwardly extending detent to engage the neck of the vial. The adapter member is configured to align the needle with the septum of the vial. The legs are sufficiently flexible to snap over the neck of the container to attach and separate the vial from the adapter member.

The syringe assembly in one embodiment has guide member with a shape and configuration for connecting with the adapter member. The guide member has a shape and configuration for stabilizing the needle and syringe while the needle pierces the septum of the vial. The guide member can have a non-circular shape that mates with the adapter having an axial opening with a non-circular shape complementing the shape of the guide member.

The guide member can have at least one and typically a plurality of radially extending ribs where the opening in the adapter member has at least one recess, groove or channel for receiving the ribs on the guide member. The opening in the adapter has a shape and length to enable the guide member to slide into the opening of the adapter so that the needle can pierce the septum of the vial. The opening in the adapter member has an axial length to stabilize the syringe and inhibit angular movement with respect to the axis of the opening in the adapter.

The features are basically attained by providing a syringe assembly comprising a syringe barrel having a proximal end and a distal end, a needle hub coupled to said distal end of the syringe barrel, and an adapter member for connecting to a vial or container. The adapter member is connected to an open end of the vial and has an axial opening with a shape complementing the shape of the distal end of the needle hub. The adapter is configured for supporting and guiding the needle hub of the syringe barrel and needle when the needle is advanced to pierce a septum on the vial.

The features of the syringe assembly are also provided by a syringe barrel having a proximal end and a distal end, and a needle hub coupled to the distal end of the syringe barrel. The needle hub has a non-circular outer surface. An adapter is configured for coupling to an open end of a vial that contains a medication, where the adapter has an axial opening with an inner surface having a configuration complementing shape and dimension of the non-circular needle hub.

A method is provided for filling a syringe for use in injecting a medication to a subject. The method comprises providing a syringe assembly comprising a syringe barrel having a proximal end and distal end, a needle hub coupled to the distal end of said syringe barrel where the needle hub has a distal end with a non-circular configuration. An adapter member is coupled to an open end of a vial and has an axial opening. The distal end of the needle hub is guided through the open end of the adapter member where the needle pierces a septum on said vial where the syringe can be filled with a substance from the vial. The syringe is separated from the adapter member whereby the syringe is ready for use.

These and other features of the invention will become apparent from the following detailed description of the invention, which in conjunction with the drawings disclose various embodiments of the invention.

### BRIEF DESCRIPTION OF THE DRAWINGS

The following is a brief description of the drawings in which:

FIG. 1 is a perspective view of the syringe and adapter member for attaching to the vial and for guiding the syringe and needle while aspirating in one embodiment of the invention;

FIG. 2 is a perspective view of the adapter member of FIG. 1;

FIG. 3 is a top view of the adapter member in the embodiment of FIG. 1;

FIG. 4 is a cross-sectional view of the adapter member taken along line 4-4 of FIG. 3;

FIG. 5 is a cross-sectional side view of the assembly showing the needle piercing the septum in the vial in the embodiment of FIG. 1;

FIG. 6 is a top view of the adapter member in another embodiment;

FIG. 7 is a partial cross-sectional side view of the adapter member taken along line 7-7 of FIG. 6;

FIG. 8 is a cross-sectional view of the assembly showing the needle piercing the septum;

FIG. 9 is a perspective view of the adapter in a further embodiment;

FIG. 10 is a top view of the adapter of FIG. 9;

FIG. 11 is a partial cross-sectional view showing the guide surfaces of the adapter of FIG. 9; and

FIG. 12 is a cross-sectional view of the adapter taken along line 12-12 of FIG. 9.

### DETAILED DESCRIPTION OF THE INVENTION

The syringe assembly of the invention refers to a syringe having a needle or cannula for injecting a medication or other substance into a patient. The terms needle and cannula are used herein interchangeably to refer to a thin tubular member having a sharp end for insertion into an injection site on a subject. A distal direction is in the direction; toward the injection site, and the proximal direction is the opposite direction. The axial direction refers to a direction along or parallel to the longitudinal axis of the syringe needle and the needle hub, and the radial direction refers to a direction perpendicular to the axial direction.

The intradermal layer in adults generally has a thickness of around 2 to 3 mm, so that intradermal injection depth is in a range of up to about 3 mm as measured from the outer surface of the skin. The thickness of the subcutaneous layer varies depending on the age of the patient, gender, body mass index (BMI), and the part of the body where the injection is administered. The subcutaneous region has an average thickness of about 7 mm to about 15 mm. Insulin is preferably delivered to the subcutaneous region. Insulin injections are commonly injected using a 4 mm needle.

The syringe assembly is suitable for use in a method for injections and for injecting a drug to a patient. The description of the embodiments is not to be deemed as limiting the invention. The disclosure is intended to enable the artisan of ordinary skill to practice variants of the invention described without departing from the scope of the invention. Numerical limitations herein, in the specification and in the claims, are understood to be limited by the modifier “about,” such that minor departures yielding equivalent results is within the scope of the invention. Features or dependent claim limitations disclosed in connection with one embodiment or independent claim may be combined in another embodiment or with a different independent claim without departing from the scope of the invention.

The invention is directed to a syringe assembly that is configured for connecting to a container such as a vial or other vessel containing a medication to facilitate filling and aspirating syringe. In the description of the embodiments, the term vial and container can be used interchangeably and define a vessel containing medication, such as insulin, for filling the syringe where the syringe can be used to inject the medication to the patient. Referring to the drawings, the syringe assembly 10 includes a syringe barrel 12 having a proximal end and a distal end 16. The proximal end receives a movable plunger and stopper for dispensing the substance contained in the syringe assembly in a typical manner. The syringe barrel and plunger have a standard structure known in the art and are not shown for clarity. An adapter member 32 connects to a vial 36, container, or other vessel containing a drug or other pharmaceutical for aspirating the syringe.

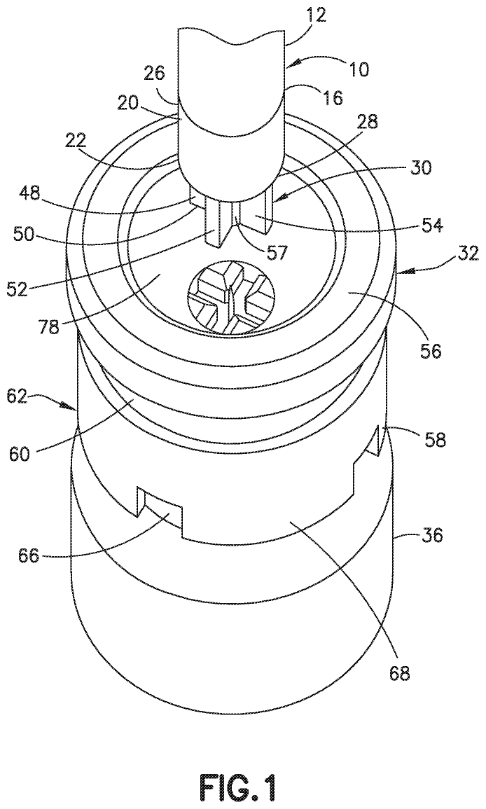

A needle hub 20 is coupled to the distal end 16 of the syringe barrel 12 as shown in FIG. 1. The needle hub 20 includes a needle 22 extending axially from the needle hub for dispensing the contents of the syringe barrel by depressing the plunger in a conventional manner. The needle hub 20 is configured for coupling to the distal end of the syringe barrel 12. The needle hub 20 has a substantially cylindrical body with a proximal end 26. A distal end 28 face axially outwardly for contacting the surface of the skin of the patient during use.

The needle 22 in the embodiment shown has a length of about 4-6 mm extending from the distal end of the syringe although the exposed length of the needle can vary depending on the particular needs of the syringe apparatus. The syringe assembly as described is primarily intended for use with shorter needle lengths, such about 4 mm that can be difficult to pierce a septum of a vial compared to longer needle lengths. The shorter needle lengths can be difficult to pierce the septum in a straight line to fill the syringe. The needle 22 has a sharp distal tip and a for communicating with the syringe barrel in a typical manner.

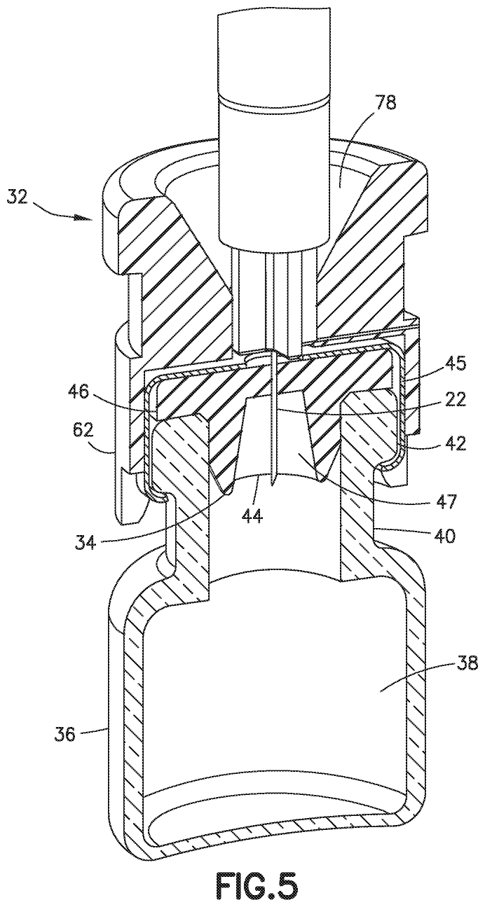

Referring to FIG. 1, distal end 28 of the needle hub 20 includes a guide member 30 for mating with the adapter 32 to guide the needle through a septum 34 of vial 36 or other container that contains a medication, such as insulin. As shown in FIG. 5, the vial 36 defines a container for storing the medication until ready for use. The vial 36 has an internal cavity 38 and a neck 40 with an outwardly projecting annular lip 42. The septum 34 fits into the open end of the vial 36 to seal the vial 36. The septum 34 has an annular shaped collar 44 that extends into the neck 40 for coupling to the vial by a friction fit. The annular shaped collar 44 forms an internal space 47 communicating with the cavity 38 of the vial 30. A top wall 46 having a flat outer face contacts the top end of the neck 40 The top wall 46 has thickness to enable the needle 22 to pierce the septum 34 and extend into the internal space of the collar 44 for filling the syringe. A cap 45 is typically provided over the septum to secure the septum to the vial. The cap 45 can be metal film press fitted or crimped over the septum to wrap around the lip of the vial as shown. A central open area of the top face of the cap shown in FIG. 5 exposes a portion of the top wall of the septum for enabling the needle to pierce the septum 34.

The needle hub 20 includes the guide member 30 extending axially from the distal end of the needle hub. The guide member 30 has a shape and configuration for mating with the adapter 32 to guide the needle 22 through the septum 34 so that the end of the needle is positioned in the cavity 38 of the vial 36 for filling the syringe. The needle 22 can extend from the guide member 30 a distance to provide an exposed length of the needle suitable for injecting the medication to a desired depth into the patient. In the embodiment shown, the exposed length of the needle is about 4 mm extending from the distal end of the guide member 30 although the length can vary as needed.

The guide member 30 has an outer surface with a configuration for mating with the adapter 32 to control the angle and orientation of the needle and guide member with respect to the vial and the septum in the vial. The guide member 30 and adapter 32 have cooperating and complementing surfaces to center the needle in the septum 34 so the needle can properly pierce the center of the septum into the internal space of the annular collar 44 for filling the syringe. Needles having a length of 4 mm or less must pierce the septum in the thin portion of the top wall, which is typically the center, to be able to penetrate the cavity 38 containing the medication. The guide member 30 and adapter 32 provide a mechanism for centering the needle in the septum and the vial and for guiding the needle along the center axis of the septum 34 and annular collar 44 for filling the syringe. The guide member 30 and the adapter 32 maintain the axial alignment of the needle with the septum and resist angular movement of the needle relative to the center axis that can cause the needle to bend or misalign with the cavity of the vial.

In the embodiment shown, the guide member 30 has a non circular outer surface for mating with a non-circular opening in the adapter 32. The guide member 30 can have a plurality of planar surfaces or curved surfaces that mate with corresponding surfaces in the axial opening 76 in the adapter member 32. The guide member 30 as shown has at least one rib 48 forming the non-circular outer surface. The guide member 30 typically has a plurality of ribs 48 space around the circumference of the guide member 30. In the embodiment shown, the guide member has four ribs 48 extending radially outward from the body of the guide member. The ribs 48 have a longitudinal length extending axially from the distal end of the needle hub 20 to provide a length sufficient to stabilize and guide the needle while passing through the adapter and piercing the septum 34 and filling the syringe.

The ribs 48 have a substantially planar configuration having a radial dimension and a longitudinal dimension. The ribs 48 have a distal face 50 that can form a skin contact surface when the needle penetrates the surface of the skin to limit the depth of penetration and control the distortion of the skin during penetration. The ribs 48 have a radially facing outer surface 52 extending the length of the respective rib and extending longitudinally parallel to the axis of the needle hub and needle. In the embodiment shown, the ribs 48 have opposite parallel sides 54 where the sides of an adjacent rib converge at the center body 57 of the guide member 30. The ribs 48 in the embodiment illustrated form the guide member having a substantially X-shape cross section. As shown, the needle 22 extends axially from the guide member.

In one embodiment, the guide member 30 is integrally formed with the distal end of the needle hub 20. The ribs 48 and the center body 57 extend axially from the distal face of the needle hub 20. The body 57 and the needle hub 20 have an axial bore that receives the needle 22. The guide member 30 can be fixed to the needle and hub. The ribs 48 and the center body 57 extend axially from the distal thee of the needle hub 20. The body 57 and the needle hub 20 have an axial bore that receives the needle 22. The needle 22 extends through the bore of the body 57 and needle hub 20 to communicate the cavity of the syringe barrel for filling the syringe and delivering the substance or medication from the syringe to the patient.

In one embodiment, the guide member 30 is a separate member that can be removed from the needle and needle hub. The body 57 of the guide member 30 has an axial bore with a dimension for receiving and sliding on the needle 22. The guide member 30 can slide onto the needle 22 with the needle passing through the bore until the proximal end of the body 57 and the ribs 48 contact the distal end of the needle hub 20 with the distal end of the needle 22 extending from the guide member 30. The bore can have a dimension relative to the outer diameter of the needle so that guide member is retained on the needle by a friction fit. The guide member 30 can then guide the needle through the opening in the adapter 32 for filling the syringe 10. After the syringe 10 is filled, the needle is withdrawn from the vial. The guide member 30 can be separated needle by sliding off the needle. Alternatively, the guide member 30 can remain in place during use of the syringe to reduce the exposed length of the needle during use of the syringe.

The adapter 32 is configured to attach to the open end of the vial 36 and cooperating with the syringe and guide member 30 extending from the needle hub. The adapter 32 has an open top end 56 and an open bottom end 58 and a coupling mechanism for coupling the adapter to the vial 36. The open bottom end 58 has an internal cavity with a shape and dimension for coupling with the top end of the vial 36. The adapter 32 is shown as a one-piece integrally formed member. The adapter can be made of a suitable material that is able to couple to the vial to support the guide member and syringe while the needle penetrates the septum on the vial. The adapter 32 can be made of molded plastic material that is sufficiently flexible to attach to the vial.

The adapter 32 has a substantially circular shape with a body 60 having a depending collar 62 forming the open bottom end 58. The collar 62 has a substantially cylindrical shape with an outer surface 64 and an inner surface. Notches 66 are cut in the bottom distal end to form legs 68. The legs 68 have an inwardly extending detent shown as a lip 70 surrounding the open bottom end 58 to define a coupling mechanism for coupling to the vial. The lip 70 has an inclined distal edge 72 for sliding over the lip 42 of the vial 36 and an inclined proximal edge 74 for enabling the separation of the adapter from the lip of the vial. The legs 68 are sufficiently resilient to snap over the lip of the vial for attaching the adapter to the vial and for separating the adapter from the vial after use. The lip 70 has a radial dimension sufficient to engage the neck of the vial 36 and attach the adapter to the vial while filling the syringe.

The outer surface of the body 60 has an annular recess 76 to assist the user in manipulating the adapter when attaching and separating the adapter from the vial. The adapter 32 has an axial passage funning an axial opening 76 and an inclined guide surface 78 for guiding the guide member 30 to the axial opening 76. The inclined guide surface 78 is formed in a first section of the adapter and the axial opening 76 is formed in a section of the adapter. In the embodiment shown, the guide surface 78 at the proximal top end 56 is in the form of a conical shaped surface converging to the opening 76. The inclined guide surface 78 forms a self-centering feature for the syringe needle and guide member 30 to pierce the center of the septum of the vial. The guide surface 78 and the axial opening 76 are oriented to align with a selected location on the septum where the needle can pierce the septum in a selected location where the needle can access the contents of the vial. In the embodiments show, the selected location on the septum is an area where the needle can pierce the septum to remove the medication from the vial. The center portion or area of the septum is typically the thinnest portion so that the adapter and guide surface typically center the needle with respect to the septum.

The axial opening 76 extends through the adapter 32 and has a shape and dimension complementing the shape and dimension of the guide member 30 to enable the needle to pass through the septum and into the cavity of the vial. The axial opening 76 has a non-circular shape complementing the outer surface of the guide member 30. In the embodiment shown, the axial opening 76 has substantially X-shape corresponding to the cross sectional shape of the ribs of the guide member.

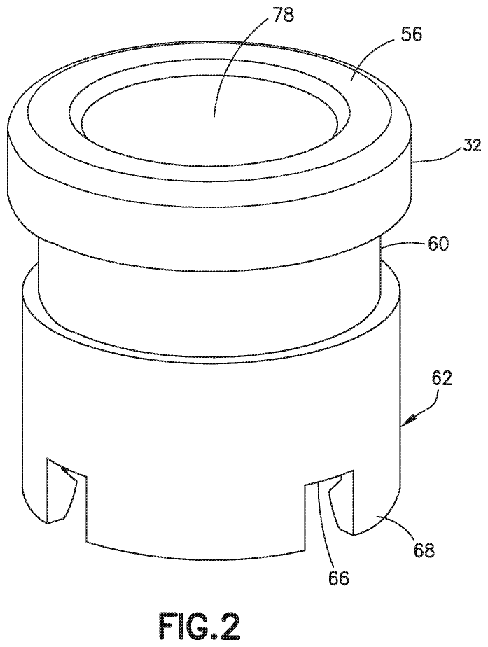

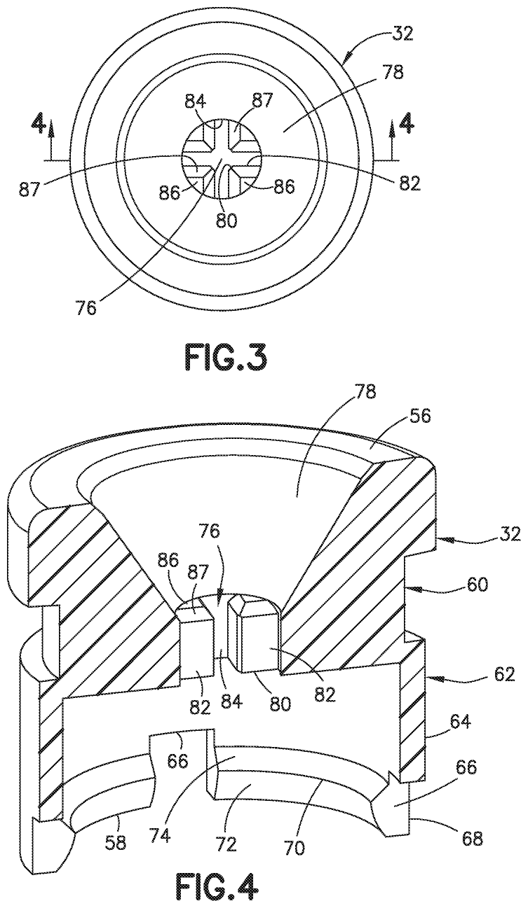

Referring to FIGS. 3 and 4, the axial opening 76 is formed by inwardly extending ribs 80 having a substantially triangular cross section. The ribs 80 have a longitudinal dimension extending the axial length of the axial opening 76 as shown in FIG. 4. Each of the ribs 80 has opposite side surfaces 82 oriented at substantially right angles to each other. The side surfaces 82 of the adjacent ribs 80 are spaced apart a distance to define longitudinally extending channels 84 forming the axial opening 76 and the X-shape corresponding to the cross sectional shape of the guide member 30. The ribs 80 have a bottom end surface aligned with the bottom face of the body 60 of the adapter 32 and a top end surface 86 aligned with the bottom end of the inclined or chamfered guide surface 78. The top end of the ribs 80 have an inclined, chamfered edge 87 extending between the top end surface 86 and the side surfaces 82 to assisting in guiding the guide member into and through the axial opening 76. In the embodiment shown in FIGS. 1-5 the axial opening 76 in the adapter member has an axial length less than the axial length of the guide member 30 so that the guide member does not extend completely through the axial opening when inserted into the adapter member and the adapter is seated on the septum 34 as shown in FIG. 5. The guide surface 78 and opening 76 are oriented to guide the needle to a selected location on the septum 34. In one embodiment, the guide opening 76 centers the syringe needle on the center of the septum, which is typically the thinnest portion of the septum.

During use of the syringe and adapter, the adapter 32 is attached to the open end of the vial as shown in FIG. 5 by sliding the open end of the adapter over the lip 42 of the vial 36. The lip 70 on the legs 68 of the collar 62 snap onto the neck 40 of the vial as shown in FIG. 5. The collar 62 of the adapter 32 in the embodiment shown has an inner diameter corresponding substantially to the outer diameter of the lip 42 of the vial 36 and an axial length where the bottom face of the body 60 contacts the top face of the septum 34. The syringe needle 22 and guide member 30 are inserted into the open top end of the adapter as shown in FIG. 5 where the needle passes through the axial opening 76 in the adapter 30 to pierce the septum 34. The open top end of the adapter assists the user in orienting the needle substantially perpendicular to the top face of the septum and parallel to the axis of the annular collar 44 of the septum so that the needle passes into the open cavity of the collar 44 for accessing the medication in the vial. The guide member 30 is aligned with the axial opening 76 to slide through the opening to orient the needle and syringe perpendicular to the axis of the vial and to orient the needle at the center of the septum where the needle can pierce the septum to receive the contents of the vial and fill the syringe in a normal manner. In the embodiment shown in FIG. 5, the guide member 30 has an axial length greater than the axial length of the opening 76 so that the distal end of the guide member 30 contacts the top face of the septum 34 when inserted into the adapter. The syringe and the vial 36 are normally inverted relative to the position shown in FIG. 5 so that the contents of the vial cover the lumen of the needle. The plunger is retracted to transfer the contents of the vial to the syringe. Excess air can be aspirated into the vial. The needle is separated from the vial and the adapter so that the syringe is ready for use.

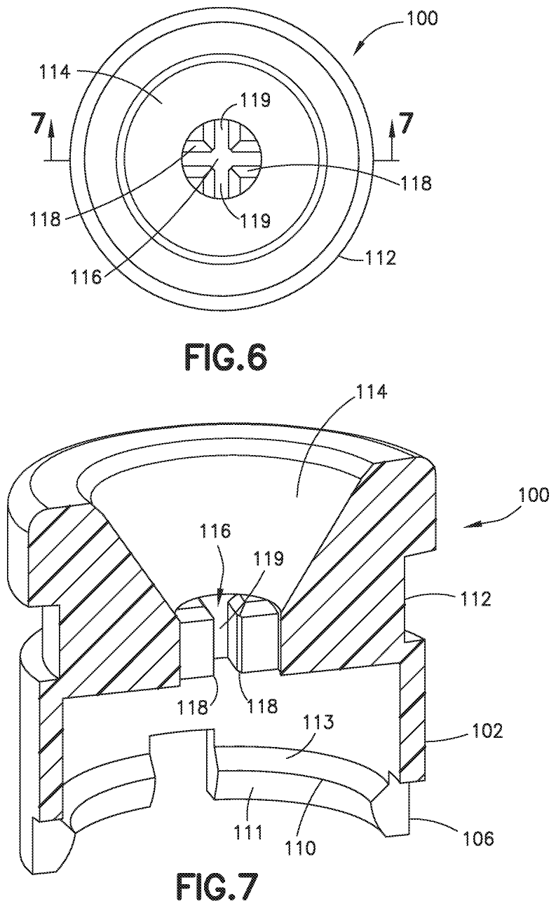

FIGS. 6-8 show another embodiment where the adapter 100 is similar to the previous embodiment and where the adapter has a cylindrical body 112, a collar 102 extending from the body 112. The collar 102 includes legs 106 for coupling to the open end of a vial 108. As in the previous embodiment, an inwardly extending lip 110 is formed on the legs 106. The lip 110 has a radial dimension sufficient to grip the collar of the vial 108. The lip 110 has an inclined distal surface 111 and an inclined proximal surface 113 to slide over the lip of the container 108. The adapter 100 is configured for use the syringe 10 and guide member 30 of the previous embodiment. The elements of the syringe and guide member are identified by the same reference numbers of the embodiment of FIGS. 1-5. The adapter 100 is configured for connecting to the vial 108 and cooperating with the syringe and guide member as in the previous embodiment. As shown in FIG. 7, the inclined distal surface 111 and the inclined proximal surface 113 to allow the lip 110 to slide over the neck of the vial 108.

A body 112 of the adapter 100 has a conical shaped recess 114 in the open top end of the adapter. An axial opening 116 extends axially through the body 112 to the cavity formed by the collar 102 as shown in FIG. 7. Ribs 118 project inwardly from the inner surface of the opening 116 to form axially extending channels 119 and an X-shaped passage for receiving the syringe 10 and guide member 30 as in the previous embodiment.

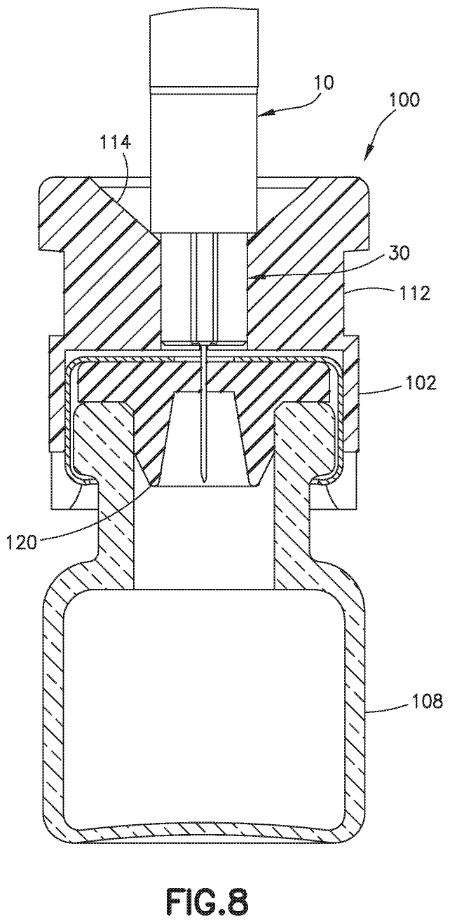

In the embodiment of FIGS. 6-8, the axial opening 116 has an axial length corresponding substantially to the axial length of the guide member 30 as shown in FIG. 8. The axial length of the axial opening 116 enables the distal end of the guide member 30 to contact the top end of the septum 120 of the vial with the distal end of the needle hub 20 contacting or closely spaced from the inclined surface 114 of the open end of the adapter 100. In the embodiment shown in FIGS. 6-8, the axial length of the axial opening 116 is greater than the embodiment of FIGS. 1-5 relative to the axial length of the guide member 32. The angle of the inclined surface is steeper and the axial depth of the opening 114 is less than in the embodiment of FIGS. 1-5.

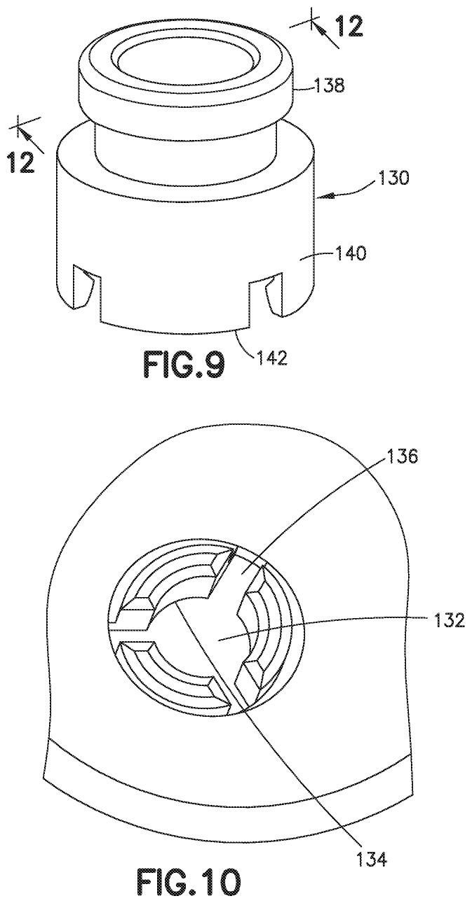

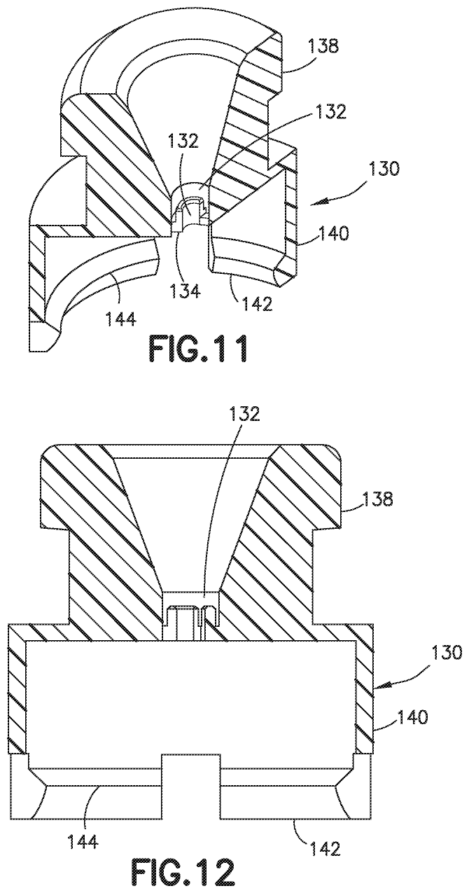

FIGS. 9-12 show another embodiment of the adapter 130 for coupling to the open end of the vial as in the previous embodiments. In the embodiment of FIGS. 9-12, adapter 130 has an axial opening 132 with a shape for receiving a syringe 10 and guide member extending from the syringe as in the previous embodiments. The axial opening 132 has inner surface with inwardly extending ribs 134 that are spaced apart from each other to form a channel 136 between the adjacent ribs 134 as shown in FIG. 10. The guide member on the syringe will have a corresponding number of ribs for each groove to pass through the axial opening in a similar manner as the previous embodiment. In this embodiment, the guide member will have three ribs for mating with the three grooves 136 in the axial opening 132.

As in the previous embodiments, the adapter 130 has a body 138 and a collar 140 extending from the bottom end of the body 138 for coupling to the vial. The collar 140 is formed with flexible legs 142 having an inwardly extending lip 144 for connecting to the vial as in the previous embodiments.

The foregoing embodiments and advantages are exemplary and are not intended to be construed as limiting the scope of the invention. The description of alternative embodiments are intended to be illustrative, and not to limit the scope of the present invention. Various modifications, alternatives, and variations will be apparent to those skilled in the art, and are intended to fall within the scope of the invention. It is particularly noted that the features of different embodiments and claims may be combined with each other as long as they do not contradict each other. Accordingly all such modifications are intended to be included within the scope of this invention as defined in the appended claims and their equivalents.

1. A syringe assembly comprising:
a syringe barrel having a proximal end and a distal end, a needle hub coupled to said distal end of said syringe barrel, and a needle extending axially from said needle hub; and
an adapter configured for coupling to a container, said adapter having an axial opening with a shape complementing a shape of said needle hub and having a dimension to receive said needle hub and needle, and where said adapter is configured for connecting to a container and aligning the syringe barrel and needle relative to the adapter member when said needle is advanced to pierce a septum on said container.

2. The syringe assembly of claim 1, wherein said adapter has a distal end with a coupling member for coupling with the container.

3. The syringe assembly of claim 2, wherein said coupling member on said distal end of said adapter includes an inwardly extending detent configured for engaging a lip of the container.

4. The syringe assembly of claim 1, further comprising a guide member extending in an axial direction from a distal end of said needle hub, and where said needle extends axially from said guide member.

5. The syringe assembly of claim 4, wherein said a guide member has at least one rib extending in a radial direction with respect to said guide member.

6. The syringe assembly of claim 4, wherein said guide member includes a plurality of ribs extending axially with respect to said guide member.

7. The syringe assembly of claim 6, wherein said axial opening in said adapter has a plurality of axially extending channels complementing a respective rib of said guide member.

8. The syringe assembly of claim 7, wherein said axially extending channels have an axial length less than an axial length of said ribs, where said ribs and guide member are able to slide axially through said axial opening in said adapter.

9. The syringe assembly of claim 4, wherein said opening in said adapter has a first section with a top end and a bottom end where said top end has a width greater than said bottom end, and a second section extending from said first section, said second section having an inner surface complementing an outer surface of said guide member.

10. The syringe assembly of claim 9, wherein said first section of said axial opening in said adapter has a conical shaped surface converging to said second section forming a self centering surface for centering the needle with respect to said axial opening in said adapter.

11. The syringe assembly of claim 10, wherein said guide member has a plurality of ribs extending in an axial direction with respect to said guide member, and where said adapter has a plurality of ribs extending radially inward into said opening of said adapter to define axially extending channels for receiving said ribs of said guide member.

12. The syringe assembly of claim 11, wherein said plurality of ribs on said adapter has a top end with a beveled surface oriented for guiding said ribs of said guide member into said channels.

13. A syringe assembly comprising:
a syringe barrel having a proximal end and distal end, a needle bearing hub coupled to said distal end of said syringe barrel;
a guide member extending from a distal end of said needle hub and having an outer surface with a non-circular configuration; and
an adapter configured for coupling to an open end of a container that contains a medication, said adapter having an axial opening with an inner surface having a configuration complementing said outer surface of said guide member.

14. The syringe assembly according to claim 13, wherein said adapter has an axially extending collar forming a plurality of legs, said legs being sufficiently flexible for coupling to an open end of said container.

15. The syringe assembly according to claim 13, wherein said guide member has at least one radially extending rib, and said axial opening in said adapter has a shape corresponding to said guide member.

16. The syringe assembly according to claim 13, wherein said guide member has a plurality of radially extending ribs, and said axial opening in said adapter has a shape corresponding to said guide member.

17. The syringe assembly of claim 16, wherein said axial opening of said adapter has a plurality of radially extending ribs defining a plurality of axially extending channels for receiving a respective rib of said guide member.

18. The syringe assembly of claim 13, wherein said opening in said adapter has a first section with a top end and bottom end, where said top end has width greater than said bottom end, and a second section extending from said first section, said axial opening extending through said second section.

19. The syringe assembly of claim 18, wherein said first section of said axial opening in said adapter has a conical shaped surface converging to said second section forming a self-centering surface for centering said needle with respect to said axial opening.

20. A method for filling a syringe with a medication, comprising providing a syringe assembly comprising a syringe barrel having a proximal end and distal end, a needle hub coupled to said distal end of said syringe barrel where said needle hub has a distal end with a non-circular configuration; and an adapter member having an axial opening;
connecting the adapter to an open end of a container having a septum and that contains the medication;
guiding the distal end of the needle hub through said axial opening of said adapter member and piercing a septum on said container with said needle and filling said syringe barrel with a medication from the container; and
separating said syringe from said adapter member.

21. The method according to claim 20, wherein said needle hub of said syringe has guide member forming said non-circular configuration, said method comprising;
sliding the guide member and needle through said axial opening in said adapter member whereby said needle pierces the septum on the container.

22. The method according to claim 21, wherein said guide member has a plurality of radially extending ribs defining said non-circular configuration, and said axial opening in said adapter member has a plurality of inwardly extending ribs forming a plurality of axially extending channels for receiving a respective rib of said guide member.
